(19) United States
(12) Patent Application Publication
(10) Pub. No.: US 2007/0145099 A1
(43) Pub. Date: Jun. 28, 2007

(54) Particle resonance sensing apparatus for identifying particles suspended in air using ping and ring functions

(76) Inventor: Robert W. Beckwith, Clearwater, FL (US)

Correspondence Address: Leo J. Aubel, 111 Riverswhire Lane, Lincolnshire, IL, 60069, US

(21) Appl. No.: 11/401,027

(22) Filed: Apr. 10, 2006

Related U.S. Application Data
(60) Provisional application No. 60/754,451, filed on Dec. 28, 2005.

(51) Int. Cl. A47J 36/02

(52) U.S. Cl. 228/101

(57) ABSTRACT

A particle identification detector of airborne particles of interest is contained in a battery operated 4″×4″×1.5″ box. Air is drawn through an internal chamber for analysis by pinging a sampling pad along the chamber with scanning microsecond bursts varying from 2 to 4 gHz. Resultant emf rings received from the particles by the pad are amplified and their amplitudes measured and stored in tables vs frequency of the ping thus forming signature profiles for particles of interest. Correlations between unknown measured profiles and tables of known profiles are used for particle identification. The box may be opened permitting the chamber to be cleaned. When used with hazardous material, the box may be placed in a clean room with wireless communications to a service computer located outside the room.

This utility patent application claims the filing date of provisional patent application Ser. No. 60/754,451 submitted on Dec. 28, 2005. REFERENCES 1 U. S. Pat. No. 6,877,358 B: “PROGRAMMABLE APPARATUS USING MOLECULAR RESONANCES FOR MEASURING PARTICLES SUSPENDED IN AIR issued Apr. 12, 2005 to Robert W. Beckwith. The present invention is an expansion of U.S. Pat. No. 6,877,358 B2.

### SUMMARY

The Particle Resonance Device (PRD™) for sensing particles suspended in air consists of a box having a fan pulling air through a filter into a chamber. Circuitry places a high frequency ping on particles of interest suspended in air and determines the ring from the particles. Spectra of rings vs ping frequency are used as means for determining presence of various particles of interest.

A first embodiment is a package primarily for laboratory use in obtaining spectra for identifying specific particles of interest. Other uses for the first embodiment are in automated or robotic applications not using direct human control.

A second embodiment is for a user to carry for protection from a list of particular particles of interest downloaded from the users service computer.

The PRD™ device has an easily changed input air filter, selected in accordance with the particles expected. This filter can be frequently changed as it gets dirty. The first embodiment box can be opened, using thumb screws, and cleaned of accumulated dirt. The second embodiment can be opened at a hinged joint and cleaned of accumulated dirt, Pings are generated by a Voltage Controlled Oscillator (VCO) in the frequency range from 2 gHz to 4 gHz. This forms a frequency spectrum useful in identifying particles of interest. Pings, in the form of a voltage pulse, are fed to a PAD so as to create an electromagnetic, field to excite particles passing under the PAD which is placed along a chamber through which air containing particles of interest is drawn by a fan.

A ring receiver uses a high gain amplifier followed by a high frequency rectifier charging capacitors for a program controllable length of time. The voltage acquired at the end of the ring period is converted to digital values by an analog to digital converter giving a ring amplitude detection range of 512,000,000. A table of ring amplitudes vs. ping frequencies becomes a particle identifier table.

The length in time of a ping is fixed at the time that it takes to turn the VCO on and off. A curve of ping frequency vs control voltage is not necessarily linear. The inventive device is calibrated with the inherent ping time length and VCO linearity, therefore neither inherent factor is of any consequence in the design and use of the inventive device.

The ring receiver has a signal amplitude formed by amplification assumed to be 50 for each of the three Gain Block Amplifiers (GBA)s together with the effective gain of a 12 bit ADC contained in Micro Controller MC 10. This gives the PingRing™ device a very wide dynamic range. Very low amplitude ring responses to certain ping frequencies are included that may be significant to certain particle identification. One particular possible particle of interest is staff germs. The presence or absence of low amplitude responses may be useful in distinguishing drug resistance staff germs from non drug resistant ones.

The first embodiment PRDT™ device is used to determine identification tables using known particles of interest. The known particle signature tables are fed to a PRDTM device service computer which holds files of such tables. BlueTooth communications is used between the PRD device and the device service computer to accommodate obtaining identification tables of hazardous materials wherein the device itself must be disposed of as hazardous waste.

First embodiment devices are also suited for use where a list of particles of interest is programmed into the device and the device deployed in an automated application where recovery of the device is not expected. A list of such applications is included in the specification of this patent application.

Second embodiment devices are intended for use by persons capable of responding to identification of selected particles of interest.

Each particle identifier has an associated particle descriptor using terms in general use. For example a list of explosive particles of interest to certain users of second embodiment devices might include black powder, C4, nitroglycerine and ammonium hydroxide (common fertilizer). Shortened forms of these terms are displayed to the user on a small display along with probabilities of presence of the named substance.

Wired USB connections to the users of second embodiment devices will generally be used. The user may often travel out of BlueTooth range from the users service computer and return to a base to communicate.

In second embodiment devices, tables are compared mathematically in the device with received signature data to determine the probability of match. The common descriptors for probable matches is then displayed to the user in a digital display. The user has an on off switch for battery power and a slide switch for scrolling up and down through the list of possible particles of interest. The particles of interest for a particular user is downloaded from the service computer into the users device before the user leaves on a specific mission.

First embodiment devices consists of a battery operated unit approximately 4″ wide by 4″ high by 1.5″ thick. The device communicates over a BlueTooth wireless connection to a support computer. This permits locating the device in a room isolated from the support computer as may be required for obtaining signature data for hazardous material.

A second embodiment container for the PingRing™ apparatus can be hung on a cord around the neck. An LCD display provides the user with immediate estimates of particles detected. The total measurement and particle identification is updated as often as once per second.

Alternatively the device can store data for blood analysis, using disposable filters on which a drop of blood is obtained for each analysis. Detection of AIDS is potentially possible.

### BRIEF DESCRIPTION OF THE DRAWINGS

FIG. 1. A view of a first embodiment device.

FIG. 2. A view of a second embodiment device.

FIG. 3. The circuit used in the first embodiments of the inventive device using wireless communications to a service computer.

FIG. 4. The circuit for the second embodiment of the invention including displays, switches and a wired connection to the service computer.

FIG. 5a,b. Front and back circuit board layouts of the ping and ring circuits on opposing sides of a ½″ square PAD.

FIG. 6. A depiction of a first embodiment sniffing device for providing security at airports, government buildings and secure events.

FIG. 7 A depiction of a person using a second embodiment device in a hospital environment.

FIG. 8. A depiction of a third embodiment device combined with controls for a spider like robot for finding and destroying land mines.

FIG. 9. A depiction of a fourth embodiment device mounted on an available pole and powered by the sun used to detect poisonous gas, biological hazard or other terrorist initiated airborne attacks and communicated to a command center.

FIG. 10. A depiction of a person with a second embodiment device built into protective clothing.

FIG. 11. A depiction of two persons, with second embodiment devices built into protective clothing, using spray equipment to wash down hazardous material.

FIG. 12. A depiction of a first embodiment PRD™ sniffer device UAV combination, deployed from a submarine, for flying at low altitudes over container ships on their way to port and detecting dangerous material if present in the containers.

FIG. 13a, b, &c show the top board of a PRD device FIG. 14a, b, &c show the spacer board that houses the fan and the air intake.

FIG. 15 a and b show the spacer board that forms the chamber.

FIG. 16 a, b, &c show the lower board that closes the chamber and holds digital circuits and voltage management circuits.

### DETAILED DESCRIPTION OF THE PRESENT INVENTION

The term particle of interest may include viruses, large molecules, germs, dust particles, allergy causing spores or disease parasites. Generally such particles are held apart in air suspension by negative charges on each particle.

One purpose of this invention is to build a first preferred embodiment device for discovering which particles of interest can indeed be detected and in obtaining data for designing other embodiments.

The molecular resonance of a particle of interest can be thought of as a mechanical resonance. As an analogy, one can tap (ping) ones of a collection of different bottles. By tapping (pinging) the side, the cap and the bottom of each bottle three distinct sounds (rings) can be heard. The patterns of three sounds are most likely different for each bottle. An observer who can hear the three sounds, but not see the bottles, can refer to a duplicate set of bottles to find the bottle that has the same sound pattern. The observer can identify the bottle just from the three sounds (rings).

Pings and rings are common in nature. A pile driver, for example, produces a distinct ping as the hammer strikes the top of the pile. The ring lasts for about two seconds after a ping. The ring sound is undoubtedly the sum of the mechanical resonance of the extended pile together with the harmonics of the fundamental frequency. Piles can be differentiated (As for example whether made of concrete or steel?) by frequency charts having different magnitudes of peaks at the fundamental and harmonic frequencies of the two types of piles.

It can also be noted that pile drivers do not make a sharp ping analogous to a lightning strike. Rather the “ping” sound is that of a dull thud. This thud can be represented as a band of frequencies lasting a few tenths of a second as compared to the ring which lasts for several seconds. This pile driver analogy is conceptually useful in forming thought experiments of pings and rings at gigaHertz (gHz) frequencies. One then builds hardware based on thought experiments to test their accuracy and to modify hardware as necessary.

The inventive device is referred to herein as a Ping Ring Detector or PRD™ device.

One important advantage of the present inventive apparatus, over that described in reference #1 patent, is the ability to open the case exposing the chamber through which air is pulled. This permits cleaning the chamber of accumulated material that could impede the passage of air carrying particles of interest.

While particles as small as viruses do not have dimensions supporting resonances in the 2 to 4 gHz frequency range, virus suspensions in blood may. It is known that water has a resonance of about 2.4 gHz. This is not supported by single water molecules either. It is believed that suspensions of viruses in blood may also have resonances detectable in the 2 to 4 gHz range. Only when a PRDTM is built and tested will this be known for certain.

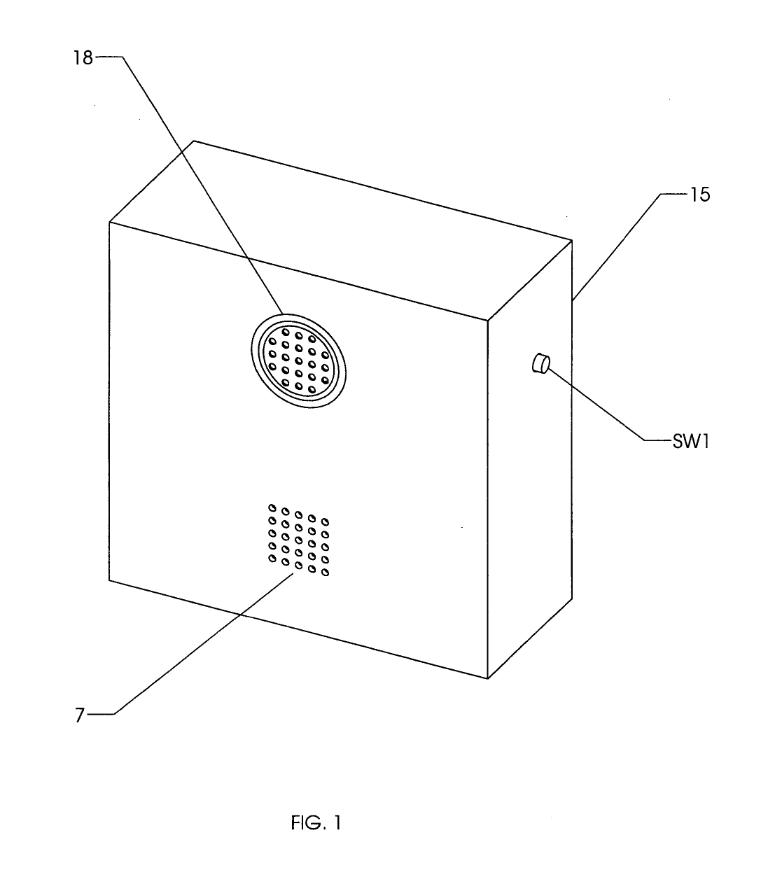

FIG. 1 shows a first embodiment device 15 for laboratory use where human contact is not directly used for control of the device. Instead control is via a user computer which uses BlueTooth wireless communications to and from the device 6.

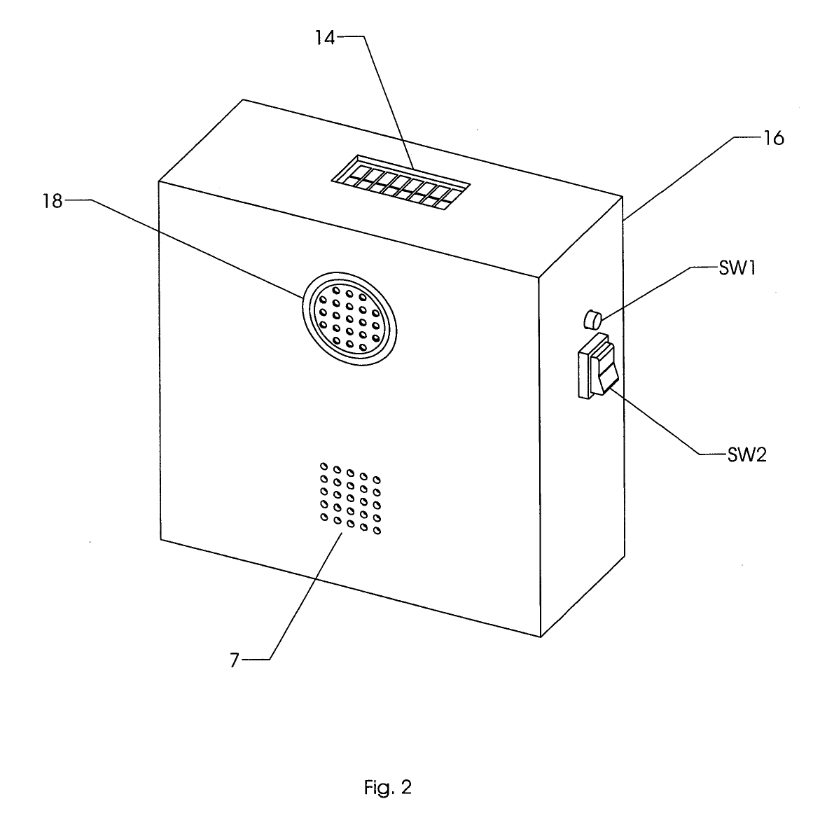

FIG. 2 shows a second embodiment device 16 for direct human use. Switch SW1 turns device 15 on and off. Switch SW2 rocks to move display 14 up or down so as to display particles of interest detected and their probability of existence in the air surrounding device 16. The particles use abbreviated forms of names for particles of interest so as to fit the screen of display 14.

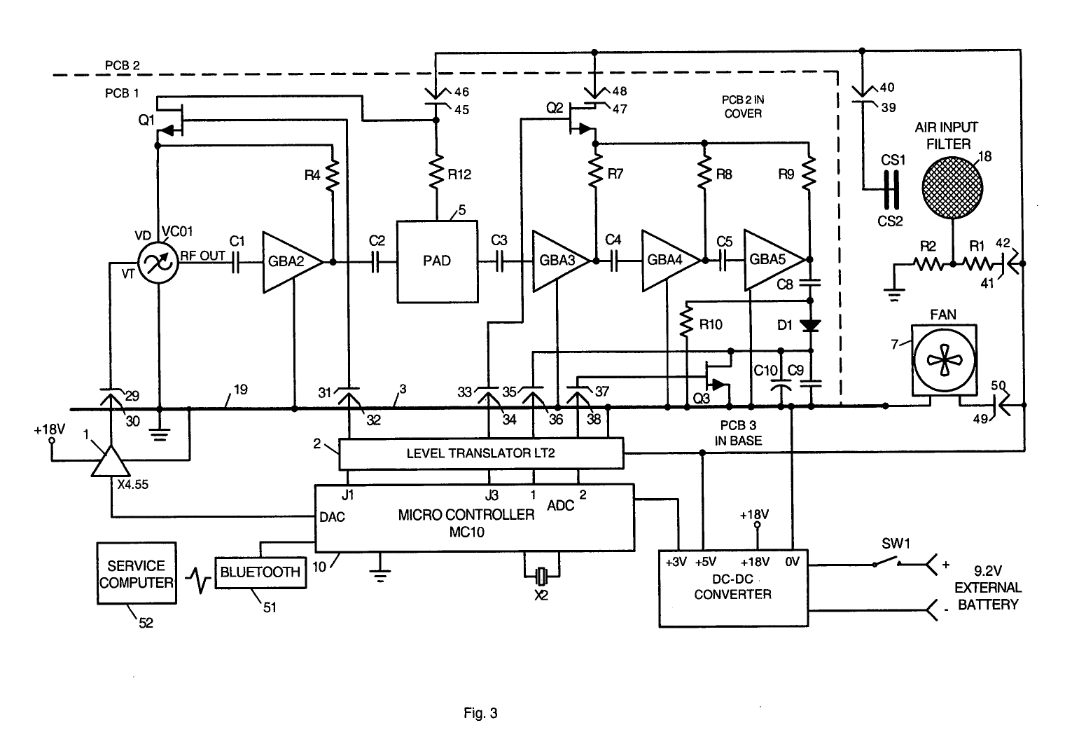

FIG. 3 shows the circuitry for a first embodiment device 15. The device 6 circuitry is contained on three Printed Circuit Boards (PCBs). The PCBs are separated by dashed lines. The horizontal ground line 19 represents chamber 3 through which air passes. It also represents the ground foil on PCB 3 which forms the bottom of chamber 3. All connections to PCB 1 are to pads on PCB1 from pins on other PCBs, This avoids the possibility of pins on PCB 1 which could resonate at frequencies in the gHz frequency region.

It is known that air passing through a chamber tends to form laminar air flow when the dimensions across the chamber are large as compared to the depth of the chamber. As a result of this information, The present invention uses a chamber 0.5″×0.1″ giving a 5/1 thickness ratio. Alternatively a spacer forming the space may be changed in thickness to provide other chamber cross sections. In particular a spacer of 0.05″ can be used giving the cross section a 10/1 thickness ratio. Experiments will be conducted to determine a most efficient ratio.

Connections between PCB 1 and PCB 3 located in the bottom of a PRD T device and PCB 3 located in the bottom of a PRD™ device is made by tiny spring pins impinging on PCB pads. Typically pins 46 and 48 on PCB 3 connect to pads 45 and 47 on PCB 1. Pin 30 on PCB 3 connects to pad 29 on PCB 1 carrying a frequency control voltage VT to Voltage Controlled Oscillator (VCO) 1. This voltage varies up to something less than 18 Vdc.

Microcontroller MC10 has a programmable Digital to Analog Converter, DAC. MC10 programs select ping frequencies by varying its DAC output to precision ×4.55 voltage multiplier chip 1, in turn connecting to the VCO 5 frequency control input.

Pin 41 on PCB 2 impinges on pad 42 of PCB 2 bringing +5 Voltage Switched (+5 VS) to equal valued resistors R1 and R2 placing 2.5 VS on air input filter 18. This voltage charges particles flowing through filter 18 to 2.5 Volts.

PCB 2 and PCB 3 are mounted in a case so as to be coupled mechanically by thumb screws holding the PRD™ device case upper half to the case lower half. This is a major feature of first embodiment devices as compared to hinged cases used for second embodiment devices.

PCB 1 is mounted at right angles across PCB 2 and includes PAD 5 as it crosses PCB 2. PCB 1 has ping transmitting circuitry to the left of PAD 5, as seen on the schematic of FIG. 3, and ring receiving circuitry to the right of PAD 5. PAD 5 should not be confused with the many pads used for connections to spring pins. PAD 5 on PCB 1 forms a part of the top of air chamber 3 with the air input filter 18 at the air input end of chamber 3 and fan 7 at the output end of chamber 3 pulling air through the chamber. PCB 1 extends either side of the chamber into free space in which the high frequency ping and ring circuits can operate properly. PCB 1 is mounted, using nylon screws, so as not to touch other PCBs whose material is conductive in the 1 to 10 gHz frequency range. This range is required by PCB 1 when all transient conditions are considered and to take advantage of the frequency range of diode D1. Pings are generated by a Voltage Controlled Oscillator (VCO) 1 in the frequency range from 2 gHz to 4 gHz. This forms a frequency spectrum useful in identifying particles of interest.

Pings, in the form of a voltage pulse, are fed to PAD 5 so as to create an electromagnetic field to excite particles passing under PAD 5. PAD 5 is placed along chamber 3 through which air containing particles of interest is drawn by fan 7.

A choice of filter pad is available, each designed to pass particular particles of interest and catch larger dust particles. Filter 18 is easily removed for cleaning or replacement without opening either type of case. A drop of blood is obtained from a short needle in a special filter used for blood analysis. Thus blood cells or AIDS viruses can be drawn through the device before drying. Blood analysis is available in about two seconds. While it is possible that AIDS can be detected with the inventive device, a device must first be constructed in order to determine what particles of interest can indeed be identified.

One intended use of first embodiment devices is for use in laboratories capable of handling particles of interest, some of which are hazardous. Known samples of particles of interest are placed on clean filter pads, the pads inserted into the inventive device and measurements made in clean rooms free of other particles. BlueTooth wireless communications is provided to the service computer allowing it to be located outside of the clean room. Other types of communications can be used if required by the service computer.

The preferred service computer is a Lonovo/IBM Thinkpad Type 1875, with 9″×12″ screen, loaded with software to support devices built in accordance with this invention.

All operation of first embodiment devices is controlled via the associated service computer.

The device is powered by an external battery, preferably one of the following JVC rechargeable lithium ion batteries operating at 9.2 Volts dc:
1. BH-VF707U
2. BH-VF714U
3. BH-VF733U

Up/down switching voltage regulator chips convert the battery voltage with their input circuits operating in parallel. They sense the supply voltage and automatically adjust to the battery voltage or to any other voltage from 3 Volts to 40 Volts. The preferred chip is a MC33063A made by ON Semiconductor. Associated components to each MC33063A chip set the output voltages to 3V, to 5V, and to 18V as required by the device.

The voltage +5 VS is connected via pin 39 and pad 40 to upper chamber 3 copper surfaces CS 1 between filter 18 and PAD 5 as well as connected by PCB 2 foil to upper chamber 3 copper surface CS 2 between PAD S and fan 7.

PAD 5 closes chamber 3 with +5 VS applied to the pad via resistor R12. With the PRD™ case closed, PCB 3 places grounded voltage reference foil closing the entire lower surface of chamber 3 thus forming a five volt gradient across all chamber 3 foils between which particles flow.

Resistors R1 and R2 hold air input filter 18 to 2.5 volts. As particles flow through filter 18 they tend to acquire charges of 2.5 volts holding them between upper and lower foils of chamber 3 and inhibiting their deposition inside the chamber. When the PRD™ device case is opened, PCB 2 and PCB 3 come apart permitting cleaning of any particles that did adhere to inside surfaces of chamber 3.

PCB 1 is made of Rogers RT Duroid 580 which is capable of supporting circuits operating within a one to ten gHz band. This material is a form of Teflon which is made slippery by having surfaces covered by electrons. The Duroid 580 is further enhanced for supporting circuits operating in the gigaHertz region by having low internal electromagnetic losses at gigaHertz frequencies.

PCB 1 extends either side of PAD 5 which closes chamber 3 without touching other parts of the PRD™ device except via interconnecting pins to pads on PCB1.

Voltage Controlled Oscillator (VCO 1) is a Phillips ARM processor. ARM stands for Advanced RISC Machine. RISC stands for Reduced Instruction Set Computer. VCO 1 is mounted on PCB 1 on the left side of PAD 5. Five volts is fed to terminal VD of VCO 4 and to transistor Q1. Transistor Q1 turn on is accomplished by a control voltage fed through pin 31 contacting pad 32. Pad 32 is energized by connection J1 of Micro Controller MC 10, as fed through Level Translator (LT) 2. The voltage from LT 2 is raised in level by LT 2, from the level of J1 on MC 10, as required for turning on transistor Q1.

MC 10 is a Phillips LPC2148 ARM Processor. Programs in MC 10 turn on transistor Q1 for approximately one microsecond for producing a ping signal on RF OUT terminal of VCO 4. The time length of the ping signal is set by the MC 10 program at a length that allows VCO 4 to completely turn on and then turn off. A curve of ping frequency vs control voltage is not necessarily linear. The inventive device is calibrated with the inherent ping time length and VCO linearity, therefore neither inherent factor is of any consequence in the design and use of the inventive device.

The ping signal from VCO 4 RF OUT is fed through capacitor Cl to Gain Block Amplifier GBA 2. GBA 2 drives an adequate ping signal into the capacitive reactance to ground of PAD 5. Capacitors C1 and C2 carry ping signals at gHz frequencies. Capacitors C3, C4, and C5 as well as C8 and C9 likewise carry ring signals at gHz frequencies. Capacitors carrying gHz frequencies are formed by lines of printed circuit foil across a non foil division line. Capacitors thus formed are expected to have capacitive reactance up to 10 gHz whereas physical capacitors may have inductive impedances at these frequencies.

Capacitors formed by PCB lines are shown herein as two parallel straight lines. Physical capacitors are shown with one straight and one curved line.

Operating current for GBA 2 is fed through resistor R4 to GBA 2 output and through GBA 2 to ground. Current for GBA 2 is also switched by Q1. VCO 5 and GBA 2 are turned on and off together in forming a ping.

While held in suspension in air passing under PAD 5, particles of interest are expected to produce ring output signals flowing through capacitor C3 to cascaded amplifiers GBA 3, 4 and 5. As ping frequencies are varied ring signals flowing through the cascaded amplifiers are expected to reach peaks of amplitude at gHz frequencies where the particles resonate. It is expected that patterns of resonant ring peaks are useable for distinguishing one type of particle from another type.

Radio frequency energy ring signals from particles are picked up by PAD 5 and passed via capacitor C3 to GBA3. Amplified signals then pass from GBA 3 output via capacitors C4 to GBA 4 input and from GBA 4 output to GBA 5 input via capacitor C5 and leave GAB 5 via capacitor C8 to rectifier D1.

Ring amplifiers GBA 3, GBA 4 and GBA 5 are switched on and off by transistor Q2 thus being on for a selected time after the ping signal has been turned off. The ping signals are turned on and off to generate the ping signal and then the ring amplifiers are turned on for the time duration of the ring, all by programs operating in Micro Controller 10 (MC 10). MC 10 control output J3 is adjusted to a proper level to control transistor Q2 by Level Translator 10 (LT 2). The Q2 control signal passes from pin 34 to pad 33 and to the Q2 control gate.

Amplified ring signals come from the output of GBA 5 through capacitor C8 to gHz capability diode D2 to charge capacitor C9. D1 is an Agilent HSMS-286B diode rated at a forward voltage drop of 0.1 Volt from 900 mHz to 10 gHz. Its size is so small that it is difficult to see without magnification and the most advanced pick and place machines must be used to mount one on a circuit board.

While capacitor C9 has a capacitance of 10 picofarads, it is connected in parallel with physical 100 picofarad capacitor C10. Available 100 picofarad capacitors appear as inductances at ring frequencies and cannot directly accept currents from diode D2. Rectified ring currents are therefore first accepted by capacitor C9 and then flow to charge capacitor C10 at rates established by the impedance vs frequency characteristics of C10.

Currents flow through resistor R10 and through diode D1, as just explained, to charge C10 during the ring period whose time duration is obtained experimentally by programs operating in MC 10. For example, the program sees an increase in voltage across C10 followed by a decrease as the ring ends. The time is set to detect the peak charge across capacitor C10. These voltages are measured by a connection across C10 through pad 35 and pin 36 and through LT 2 to 12 bit ADC input 1 of MC 10.

The voltage acquired at the end of the ring period is converted to digital values by an analog to digital converter giving a ring amplitude detection range of 512,000,000. A table of ring amplitudes vs. ping frequencies becomes a particle identifier table.

Very low amplitude ring responses to certain ping frequencies are included that may be significant to certain particle identification. One particular possible particle of interest is staff germs. The presence or absence of low amplitude responses may be useful in distinguishing drug resistance staff germs from non drug resistant ones.

Once the ADC has measured and recorded the peak ring amplitude, an ADC 2 signal is sent through LT 2, through pin 38 and pad 37 to turn on transistor Q3, shorting the voltage on C10 to zero, and ready to receive the next ring.

Crystal X2 connects to MC 10 for controlling its operation. Switch SW1 controls the connection to the external battery. A wireless USB connection, using BlueTooth technology, is shown communicating wirelessly to a BlueTooth converter 51 and received by BlueTooth compliant service computer 52.

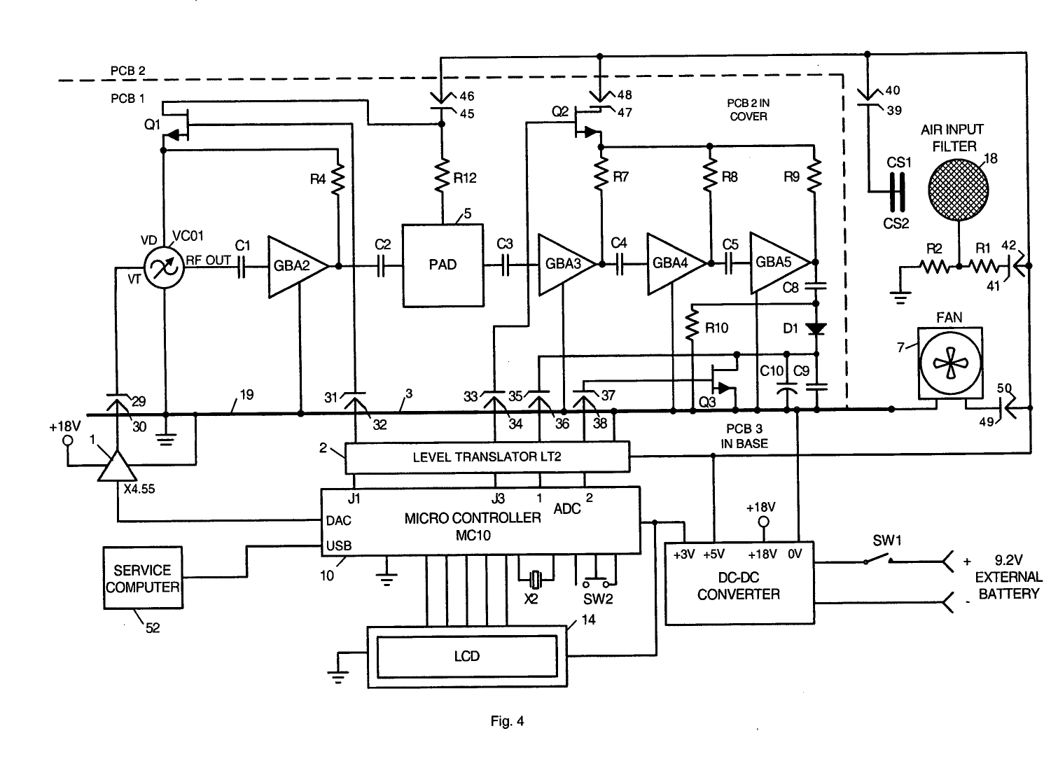

FIG. 4 shows the circuit diagram for second embodiment devices intended for use by persons capable of responding to identification of selected particles of interest. This circuit is similar to the circuit of FIG. 3 with the addition of display LCD 14 connected to MC10 and the substitution of a wired connection to service computer 52 in place of the BlueTooth connection of FIG. 3.

Each particle identifier has an associated particle descriptor using terms in general use. For example a list of explosive particles of interest to certain users of second embodiment devices might include black powder, C4, nitroglycerine and ammonium hydroxide (common fertilizer). Shortened forms of these terms are displayed to the user on a small display along with probabilities of presence of the named substance.

Wired USB connections to the users of second embodiment devices may sometimes be used. The user may travel out of BlueTooth range of the service computer and must return to the service computer to communicate. Alternatively second embodiment devices may use BlueTooth communications as shown in FIG. 3.

In second embodiment devices, tables are compared mathematically in the device with received signature data to determine the probability of match. The common descriptors for probable matches is then displayed to the user in a digital display. The user has an on off switch for battery power and a slide switch for scrolling up and down through the list of possible particles of interest. The particles of interest for a particular user is downloaded from the service computer into the users device before the user leaves on a specific mission.

A second embodiment container for the PingRing™ apparatus can be hung on a cord around the neck. An LCD display provides the user with immediate estimates of particles detected. The total measurement and particle identification is updated as often as once per second.

Alternatively the device can store data for blood analysis, using disposable filters on which a drop of blood is obtained for each analysis. Detection of AIDS is potentially possible.

Power on/off switch SW1 connects to the external battery. Three terminal automatic return to center slide switch SW2 connects to MC10. Programs in MC 10 sense slide switch SW2 and move the displayed particle of interest up and down as well as a probability of detection for each particle displayed.

Provision of supply voltages are as described above for FIG. 3.

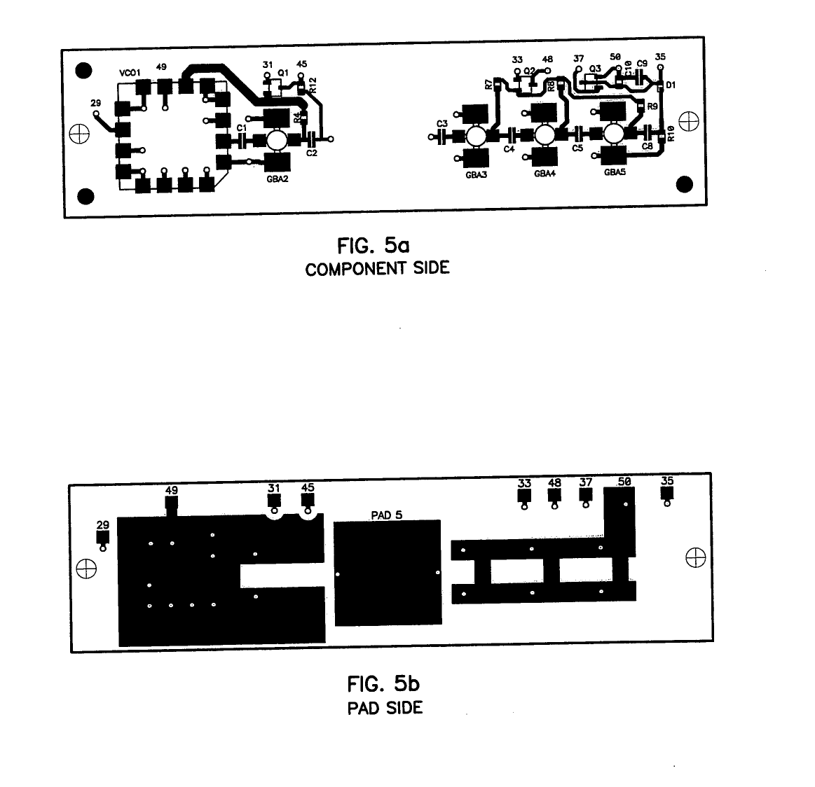

FIG. 5a shows a scale drawing of the component side of high frequency board PCB1 with space for PAD 5. The ping circuit is on the left of PAD 5 space and the ring circuit on the right of PAD 5 space. Note that capacitors C1, C2, C3, C4, C5, C8, and C9 are formed by the capacitance of printed foil lines separated by non conducting printed circuit surface. It is believed that such capacitors will not be inductive in the two to four gHz frequency range and will pass ping and ring signals without frequency related distortion.

Circuits on the board of FIG. 5 duplicate the performance of the circuit of PCB1 shown both on FIGS. 3 and 4. Note, for example that Transistor Q1 switches both VCO 1 and amplifier GBA 2 to form a ping. Further transistor Q2 switches ring amplifiers GBA 3, GBA 4 and GBA 5 on to receive a ring immediately following shutting off transistor Q1 to terminate a ping. Immediately after recording a ring, transistor Q3 turns on to remove the ring voltage from capacitors C9 and C10 making the circuit ready for another ping-ring sequence.

FIG. 5b shows pads 31, 45, 33, 48, 37, and 35 which receive signals via spring pins on other circuit boards. Also shown is PAD 5 and ground plane 49 (as recommended by the manufacturer) under VCO 1. Ground plane 50 extends under GBA3, GBA4, and GBA5 in accordance with good practice at gHz frequencies.

FIG. 6 shows a fifth embodiment of the present invention used as a backup or replacement device in a cost saving system for providing security at airports. The potential cost saving could be used instead by employing a number of inventive sniffers throughout the airport.

FIG. 7 shows a doctor or nurse with a second embodiment device hung around the neck for displaying germs carried by the atmosphere. It is expected that he will frequently exchange data with a central computer using a wired connection

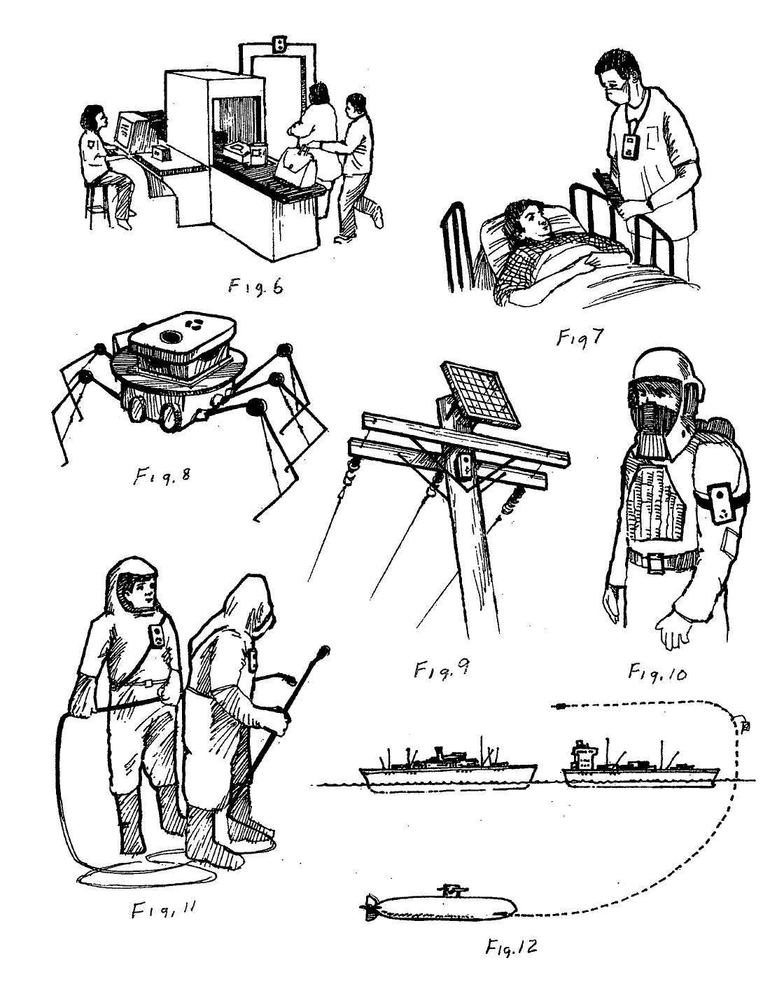

FIG. 8 shows a third embodiment of the inventive device combined with control circuitry for a spider like robot designed for clearing land mines. Hopefully the robots legs will not exert enough pressure to set off the mine. The mine may be capable of backing off once the inventive sniffer has indicated the presence of a mine. The robot may then back off and lob a small explosive charge for setting off the mine.

Alternatively the robot may carry a precision GPS receiver together with communications equipment for reporting the exact location of the mine for later removal or explosion.

FIG. 9 shows a fourth embodiment of the present invention which is mounted on poles perhaps already in existence for other uses. A solar panel and battery (or super cap) power a sniffer searching poisonous gas, hazardous biological material or other material used by terrorists. Communications equipment is included for providing results to a terrorist command center.

FIG. 10 shows a person wearing a protective suit which has a built in second embodiment device. The readout shows the user the presence of hazardous particles in the atmosphere. The readout may be in the device itself or alternatively may be combined with a readout in the users helmet put there for other purposes.

FIG. 11 shows a team of two washing down walls and equipment of hazardous substance with second embodiment units keeping them informed as to their immediate environment.

FIG. 12 shows a first embodiment device used in an Unmanned Avionic Vehicle (UAV). Such UAVs are programmed to fly at very low altitudes over ships on their way to US seaports. Detection of explosive or radioactive particles in the atmosphere downwind of the ships can be used to activate protection of seaports.

This figure envisions the possibility of submarines sending a waterproof package containing a sniffer and a UAV. At some altitude above water, the waterproof package opens and deploys the UAV to fly over cargo ships at low altitude using a sniffer from this invention to detecting airborne emissions. The equipment might or might not be recoverable.

Mechanical Construction

In reviewing the many applications of the PRD described above, a number of desirable capabilities are apparent. In fact, these characteristics may be desirable for any device required to meet the following criteria:
1. Must operate at frequencies capable of interfering with existing communications equipment.
2. Must be as small as possible.
3. Must be low cost.
4. Must be rugged in construction and in some cases explosion proof.
5. Must be easy to assemble and disassemble for maintenance and replacement of defective parts.
   To meet these requirements, equipment for the present invention or for any other device having the above criteria, the following steps are preferred:
1. No external box is used. The inventive structure forms its own box.
2. A pancake assembly of boards of various thickness and of the same size fit together in layers thus forming a box.
3. The outside edges of all boards and a mating strip of board plating exists on all boards.
4. The two board surfaces forming the top and bottom of an assembly of boards is plated with openings as required by the product design.
5. The box can be opened at a selected layer to provide access to the inside of the box.

The following Figures illustrate two preferred designs for enclosures for the present invention. These are for embodiments one and two using as many common parts as possible.

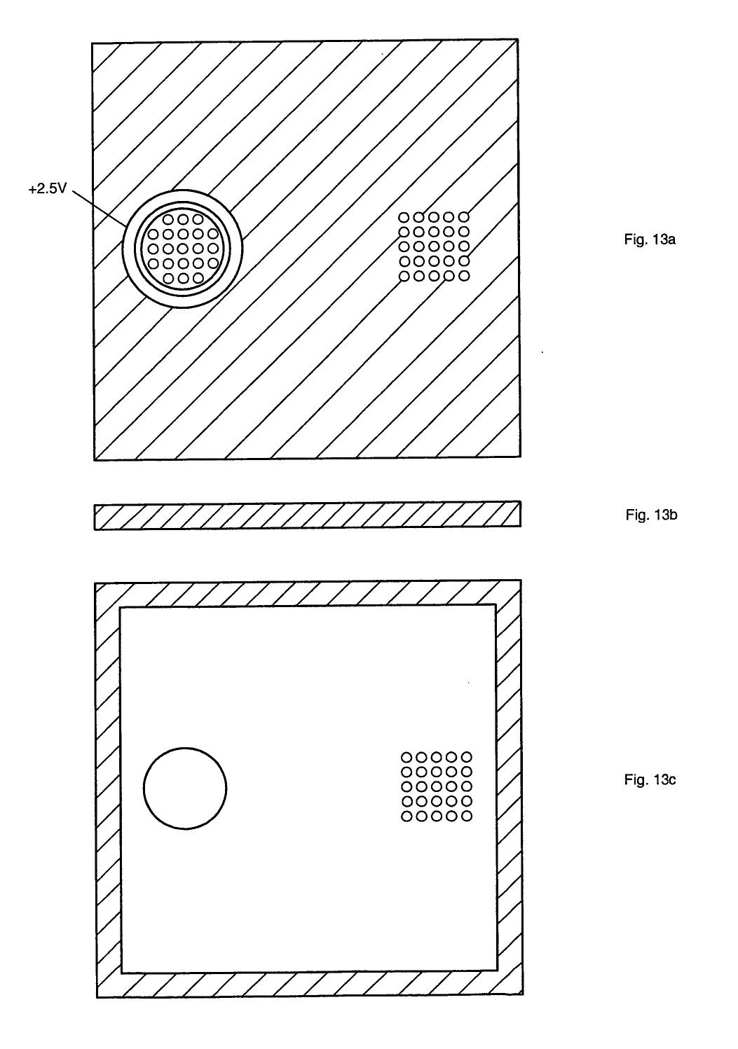

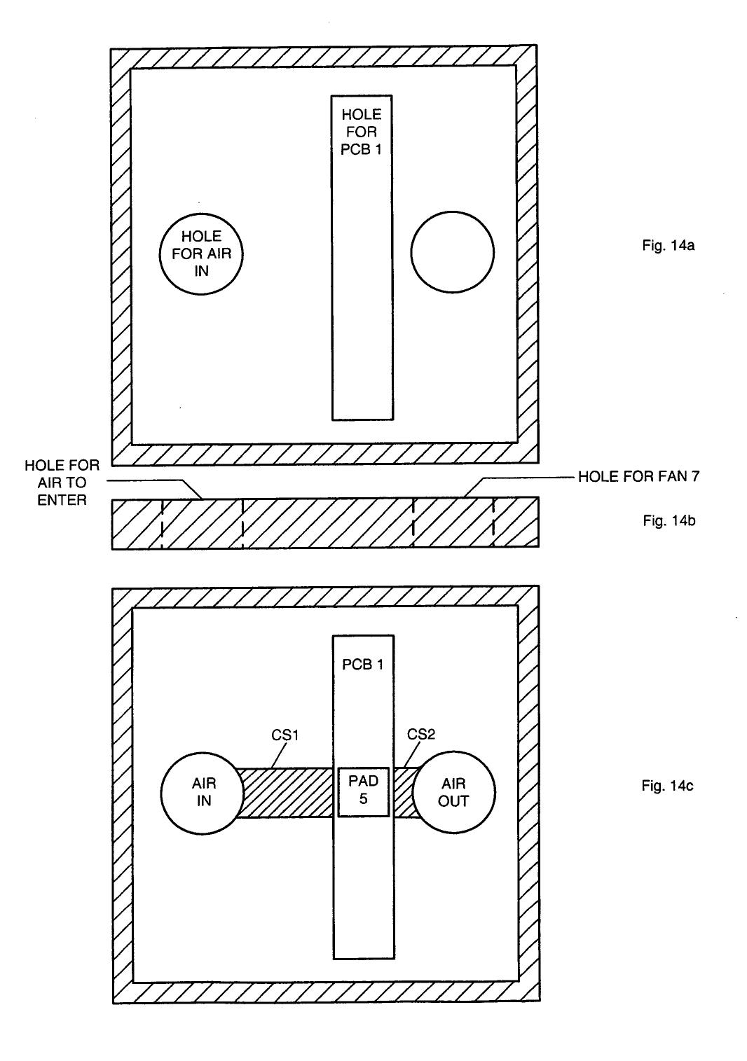

FIG. 13a shows the top board which is copper covered with holes for air to pass into the chamber 3 through a filter pad 18 and out of the chamber from the fan 7. The filter pad has an insulating ring around it permitting the placing of 2.5 Vdc on the filter pad 18. Early experiments with various smoke particles will determine whether this makes a significant improvement on the amount of particles deposited within the chamber 3. If not the charging circuit may be removed on later models of the device.

FIG. 13b shows an edge view showing the plating on the edge as with all boards so as to form a shielded enclosure when all boards are fastened together with some pressure on the stack of boards.

FIG. 13c shows a bottom view of the top board with air holes to let air in and out of the chamber 3.

FIG. 14a shows the top view of an ⅜″ thick spacer board which has space to fit fan 7 together with space for air to pass from filter pad 18 into chamber 3. A rectangular hole in this board accommodates the high frequency board PCB 1.

FIG. 14b shows a side view of the spacer board, plated on the outside for shielding of the entire enclosure with dotted lines indicating air intake and output.

FIG. 14c shows a bottom view of the spacer board with holes for air in and air out. Copper surfaces CS1 and CS2 are shown which are charged to 5 volts. PCB1 is shown with PAD 5 having a 5 volt charge to complete the 5 volt charge across chamber 3.

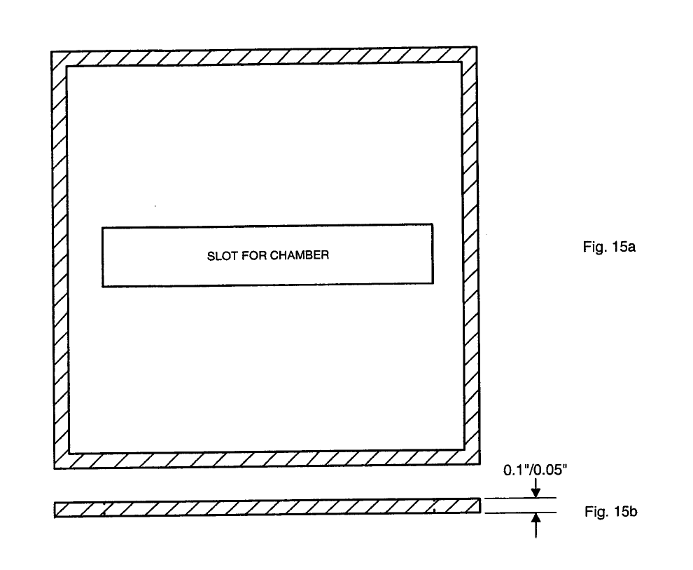

FIG. 15a and b shows a second spacer 0.1″ thick to form chamber 3.

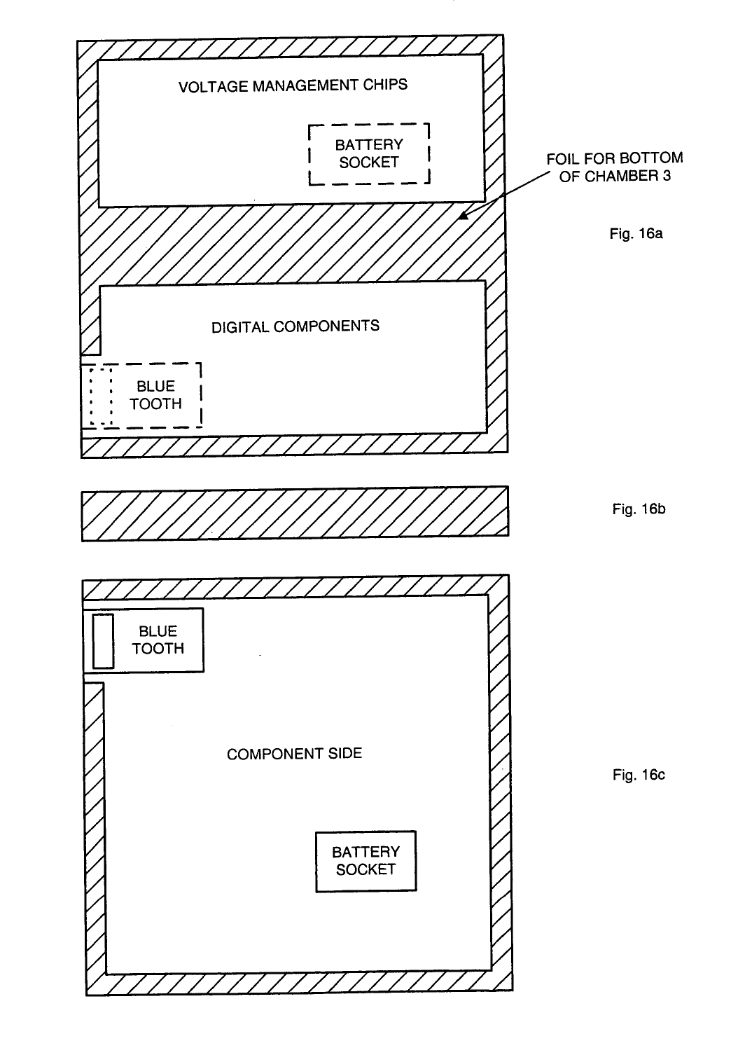

FIG. 16a shows the first board below the place where the boards can be separated for cleaning chamber 3. Copper foil closes chamber 3 and is at zero volts reference for the 5 volt charge along the top of chamber 3. A socket is shown capable of holding a 9.2 V rechargeable lithium iron battery. This battery is available in several sizes with the largest holding some 25 Watt hours of energy.

Voltage management chips located on this board supply +3V, +5V, and +18V as required by various devices as shown on FIG. 3. Other input voltages are automatically accommodated if the battery socket is used to connect to another device having a source of dc power.

FIG. 16b shows the copper covered edge of this board.

FIG. 16c shows a bottom view and a portion of the board which holds digital circuitry as shown on FIG. 3. The BlueTooth transceiver shown on FIG. 3 is shown mounted with its antenna communicating through spaces on the copper board surface.

When holding display devices and switches added for second embodiment devices as shown on circuit diagram FIG. 4, space is added under the board of FIG. 16c as required to house the display and switches.

1. A device for detecting the identity of particles of interest suspended in air comprising in combination:
a) a first multilayered printed circuit board means for forming part of a chamber for suspended particles of interest to pass through,
b) a second printed circuit board means for mating with said first printed circuit board means thus completing a chamber for suspended particles of interest to pass through,
c) fan means for pulling said air with particles of interest through said chamber,
d) electrically charged input filter means for placing a selected electric charge on said particles of interest as they are drawn into said chamber by said fan,
e) one or more first chamber conductive surface segment means for locating on said first multilayered printed circuit board for charging to voltages along a first side of said chamber at double the charge placed on said input filter,
f) a second chamber conductive surface means for locating on said second printed circuit board for forming a common reference voltage along a second side of said chamber,
g) an insulated chamber conductive surface segment for charging to double the charge placed on said input filter,
h) signal voltage means for pinging said insulated chamber conductive surface segment for forming an emf field under said conductive surface segment,
i) signal means for varying said signal voltages from two to four gHz,
j) measurement means of measuring ring signal voltage levels from said insulated chamber conductive surface segment immediately following each said ping signal, and
i) means of forming tables of ring samples taken over a selected range of ping frequencies
where the tables of ring samples are indicative of the identity of a particle of interest.

2. A device as in claim 1 further including the means for amplifying ring signal voltage levels from said insulated chamber conductive surface segment before measurement.

3. A device as in claim 1 further comprising the means for:
a) SYNERGY DCMO-190410 Voltage Controlled Oscillator (VCO) signal means for varying the frequency of the pings, and
b) micro controller means for stepping a voltage into said VCO to establish a two to four gHz band of ping frequencies.

4. A device as in claim 1 further comprising the following:
a) first high frequency capacitive coupling means for connecting ring output voltages to a high frequency diode rectifier,
b) second high frequency capacitive means for accepting rectified ring currents,
c) low frequency capacitive means for paralleling said second high frequency capacitive means for accepting currents from said second high frequency capacitive means, and
d) resistive means for feeding a current through said high frequency diode for charging said low frequency capacitive means to a voltage giving a measure of the ring magnitude.

5. A device as in claim 4 further comprising the following:
a) Analog to Digital Converter (ADC) means for measuring the voltage across said low frequency capacitive means and determining when a peak magnitude has occurred and the voltage is going down,
b) memory means for storing the peak ADC voltage,
c) transistor switching means for removing the charge on said low frequency capacitive means,
d) micro controller program means for sequencing the ping and ring procedures,
e) computer means for storing tables of known particles of interest,
f) wireless communications means between said computer and said micro controller, and
g) computer display means for displaying information concerning particles of interest and their probable identity to users of the computer.

6. A method of identifying particles of interest suspended in air comprising the following steps:
a) drawing air containing particles of interest through a chamber,
b) pinging said particles of interest with bursts of gHz emf energy as they pass through said chamber,
c) measuring the rings from said particles of interest after they have been pinged for use in determining the identity of said particles,
d) storing tables of ping frequency vs ring amplitudes for use in identifying said particles of interest.

7. A method of identifying particles of interest suspended in air, said method consisting of the steps of:
a) providing multilayered printed circuit boards having a chamber between boards forming a path for passing laminer air carrying suspended particles of interest,
b) fastening a fan to said boards for drawing air through said chamber,
c) providing a foil layer along a first side of said chamber for providing a return path for electromagnetic waves oscillating at resonant frequencies of particles of interest,
d) providing electrically separated foil segments along the opposing second side for closing said chamber,
e) placing voltages on said foil segments for forming voltage gradients across said chamber,
f) providing an electrically isolated PAD foil section for establishing electromagnetic fields between said PAD and said first side of said chamber,
g) pinging said PAD with voltages for forming electromagnetic signals under said PAD at frequencies ranging from two and four gHz,
h) rectifying ring voltages from said PAD immediately following said pings for charging capacitors, and
i) measuring peak voltages produced on said capacitors for determining the magnitudes of rings.

8. A method as in claim 7 further comprising the steps of:
a) providing analog to digital converters for measuring voltages across said capacitors,
b) providing memory for storing peak voltages across said capacitors,
c) providing switching transistors for eliminating electrical charges on said capacitors,
d) providing micro controllers for sequencing ping and ring procedures,
e) providing computers for storing tables of known particles of interest,
f) providing wireless communications between said micro controllers and said service computers, and
g) providing computer screens for displaying information concerning particles of interest and their probable identity to users of the service computer.

9. A method of pinging particles of interest suspended by electric charges in air passing through an air chamber, the method comprising the steps of:
a) providing a PAD for passing particles of interest under,
b) charging said PAD using current through a resistor to hold the PAD at a reference voltage with respect to opposite surfaces of said air chamber,
c) creating voltages on said PAD using current through a capacitor,
d) connecting ping signal voltages to said capacitor for creating ping currents through said capacitor,
e) converting ping signal currents to voltages on said PAD for creating electromagnetic ping fields in said chamber between said PAD and said PAD reference voltage by which particles of interest are exposed to electromagnetic pings as they pass under said PAD.

10. A method as in claim 9 further including the steps of:
a) varying the air flow speed to find a speed of maximum efficiency,
b) varying the length of the ping to find the length of maximum efficiency,
c) varying the frequency of the ping to find the frequency of maximum efficiency, and
d) repeating steps a) b) and c) in random orders to find overall conditions of maximum efficiency.

11. A method of constructing shielded containers for electronic equipment, the method comprising the steps of:
a) forming stacks of circuit boards for containing electronic equipment,
b) covering edges of said circuits boards with conducting material for shielding edges said circuit boards,
c) covering strips above and below said covered edges of said circuit boards for continuing the shielding of said containers when the said boards are placed in stacks,
d) covering entire top surfaces of top circuit boards in said stacks for further continuing shielding of tops of said containers, and
e) covering entire bottom surfaces of bottom circuit boards in said stacks for completing the shielding of said containers.

12. A method as in claim 11 further including the steps of:
a) using screws and threaded receptacles for said screws for holding all said circuit boards together, and
b) using mating sizes, shapes and thicknesses of circuit boards for constructing shielded containers for electronic equipment.

13. A method as in claim 11 further including the steps of:
a) placing components together with interconnecting printed circuit connections for said electronic equipment for forming useful equipment, and
b) placing holes in said circuit boards as required to provide space for said components of electronic equipment.
